(19) United States
(12) Patent Application Publication
(10) Pub. No.: US 2026/0326963 A1
(43) Pub. Date: Oct. 22, 2026

(54) APPLICATOR ARRRANGEMENT, LABEL APPLICATOR AND METHOD FOR APPLYING A LABEL TO AN OBJECT

(71) Applicant: Dover Europe Sàrl, Vernier (SE)

(72) Inventor: Jonas Södergård, Vastra Frolunda (SE)

(21) Appl. No.: 19/100,470

(22) PCT Filed: Aug. 1, 2023
(86) PCT No.: PCT/EP2023/071307

§ 371 Date: Jan. 31, 2025

(30) Foreign Application Priority Data
Aug. 1, 2022 (SE) 2250937-6
Aug. 1, 2022 (SE) 2250938-4
Aug. 1, 2022 (SE) 2250939-2
Aug. 1, 2022 (SE) 2250940-0
Aug. 1, 2022 (SE) 2250941-8
Aug. 1, 2022 (SE) 2250942-6
Aug. 1, 2022 (SE) 2250943-4
Aug. 1, 2022 (SE) 2250944-2

(51) Int. Cl. B65C 9/36; B65C 9/18; B65C 9/30; B65C 9/34; B65C 9/40

(52) U.S. Cl. CPC B65C 9/36; B65C 9/18; B65C 9/30; B65C 9/34; B65C 9/40

(57) ABSTRACT

The present disclosure relates to applicator arrangement comprising: a label applicator configured to apply a label to an object; and a label holder configured to hold the label, wherein the label holder comprises an opening; wherein at least part of the label applicator is configured to: pass through the opening of the label holder in a first direction, so as to (i) touch the label held by the label holder when the label extends at least partly over the opening and (ii) apply the label to the object; and pass through the opening in a second direction that is opposite to the first direction.

### TECHNICAL FIELD

The present disclosure relates generally to an applicator arrangement, a label applicator, a method, a control unit, a computer program product and a non-transitory computer-readable storage medium. More particularly, the present disclosure relates to enabling a label to be applied onto an object.

### BACKGROUND

An applicator arrangement is used to apply labels to objects such as for example packages or products. Some applicator arrangements are arranged to produce the labels, for example in cooperation with a label printer.

A label is typically dispensed from a label dispenser and onto a label holder, for example a label conveyor belt. It is common to use compressed air to hold the label onto the label holder. However, from a sustainability point of view, it is desirable to avoid the use of compressed air. There is a growing demand for sustainable products and solutions, particularly in every stage of product manufacturing. Label printers and especially industrial label printers are utilized at various points in a production line and are included in sustainability requirements. Industrial label printers are specifically designed for heavy-duty, continuous use in larger-scale labelling operations commonly found in warehouses, factories, and distribution centers. These label printers can produce thousands of labels per day. Additionally, industrial label printers may also include a label application component, collectively referred to as Print and Apply (P&A) machines.

In some applications, labels need to be automatically applied at high speed onto objects with varying and uneven surfaces. One example of such an application is logistics, where there is often a mix between boxes and bags of different sizes. It is also important to make sure that the label applicator does not get stuck, for example under a cardboard tab or in a fluffy bag. Another example of such an application is food where, for example meat and cheese are objects that have surfaces that are often very uneven and varying and where the speed requirement for applying the label is also high.

The speed and efficiency of automated processes is constantly increasing. This applies also to the throughput demands on automatic labeling applications in production and logistics processes.

In view of the above, there is a strive to develop further improved technology relating to applying labels on objects.

### SUMMARY

An objective of the present disclosure is to obviate at least one of the above disadvantages and to provide improved handling of label application on an object.

According to a first aspect, the objective is achieved by an applicator arrangement for enabling a label to be applied onto an object. The applicator arrangement comprises a label applicator arranged to apply the label to the object. The applicator arrangement comprises a label holder arranged to obtain a first label from a label dispenser. The label holder comprises an opening. When the label holder has obtained the first label, at least part of the label applicator is arranged to be triggered to run through the opening in a first direction, touches the first label after the label applicator has run through the opening and to apply the first label to the object. The at least part of the label applicator is arranged to be triggered to run through the opening in a second direction after the first label has been applied to the object. The second direction is opposite to the first direction.

According to a second aspect, the objective is achieved by a label applicator for enabling a label to be applied onto an object. The label applicator comprises an outer rod arranged to at least partly encapsulate an inner rod. The inner rod is arranged to move in a first direction out of the outer rod and in a second direction into the outer rod. The label applicator comprises an applicator pad arranged to hold the label and to apply the label to the object. The applicator pad is arranged at a bottom end of the inner rod.

According to a third aspect, the objective is achieved by a method performed by a control unit for enabling a label to be applied on an object. The control unit triggers a first label to be provided from a label dispenser to a label holder. When the label holder has obtained the first label, the control unit triggers at least a part of a label applicator to run through an opening comprised in the label holder, touch the first label after the label applicator has run through the opening and apply the first label to the object. The control unit triggers at least a part of the label applicator to run through the opening in a second direction after the first label has been applied to the object. The second direction is opposite to the first direction.

According to a fourth aspect, the objective is achieved by a control unit for enabling a label to be applied on an object. The control unit is arranged to perform the method of the third aspect.

According to a fifth aspect, the objective is achieved by a computer program product comprising program code for performing, when executed by a processing circuitry, the method of the third aspect.

According to a fourth aspect, the objective is achieved by a non-transitory computer-readable storage medium comprising instructions, which when executed by a processing circuitry, cause the processing circuitry to perform the method of the third aspect.

The present disclosure herein affords many advantages, of which a non-exhaustive list of examples follows:

An advantage of the present disclosure is that it enables the label to be applied to the object in an automated and fast manner.

Another advantage of the present disclosure is that compressed air is not used, which is desirable from a sustainability point of view. Since compressed air is not used, the complexity and cost of the applicator arrangement is reduced.

A further advantage of the present disclosure is related to the speed in the applicator arrangement. The low impact label application onto uneven surfaces is associated with a low risk for the label applicator getting stuck in the object, and this makes the applicator arrangement perfectly suited for the logistics/e-com sector where there is a mix between boxes and bags of different sizes.

Another advantage of the present disclosure is that the cost for producing the applicator arrangement is low thanks to few parts. For example, no extra motor is needed to move between a feed position and a label change position. The cost is also low thanks to the fact that one machine can be used instead of two in high-speed applications. Fewer parts also provide higher operational reliability.

The present disclosure is not limited to the features and advantages mentioned above. A person skilled in the art will recognize additional features and advantages upon reading the following detailed description.

### BRIEF DESCRIPTION OF THE DRAWINGS

The present disclosure will now be described in more detail by way of example only in the following detailed description by reference to the appended drawings in which:

FIG. 1a is a schematic drawing illustrating an applicator arrangement.

FIG. 1b is a schematic drawing illustrating an applicator arrangement.

FIG. 1c is a schematic drawing illustrating an applicator arrangement.

FIG. 2 is a schematic drawing illustrating an applicator arrangement.

FIG. 3a is a schematic drawing illustrating an applicator arrangement.

FIG. 3b is a schematic drawing illustrating an applicator arrangement.

FIG. 4 is a schematic drawing illustrating an applicator arrangement.

FIG. 5a is a schematic drawing illustrating an applicator arrangement.

FIG. 5b is a schematic drawing illustrating an applicator arrangement.

FIG. 5c is a schematic drawing illustrating an applicator arrangement.

FIG. 6 is a flow chart illustrating a method.

FIG. 7 is a flow chart illustrating a method.

FIG. 8 is a flow chart illustrating a method.

FIG. 9a is a schematic drawing illustrating a label applicator.

FIG. 9b is a schematic drawing illustrating a label applicator.

FIG. 10a is a schematic drawing illustrating a control unit.

FIG. 10b is a schematic drawing illustrating a control unit.

The drawings are not necessarily to scale, and the dimensions of certain features may have been exaggerated for the sake of clarity. Emphasis is instead placed upon illustrating the principle.

### DETAILED DESCRIPTION

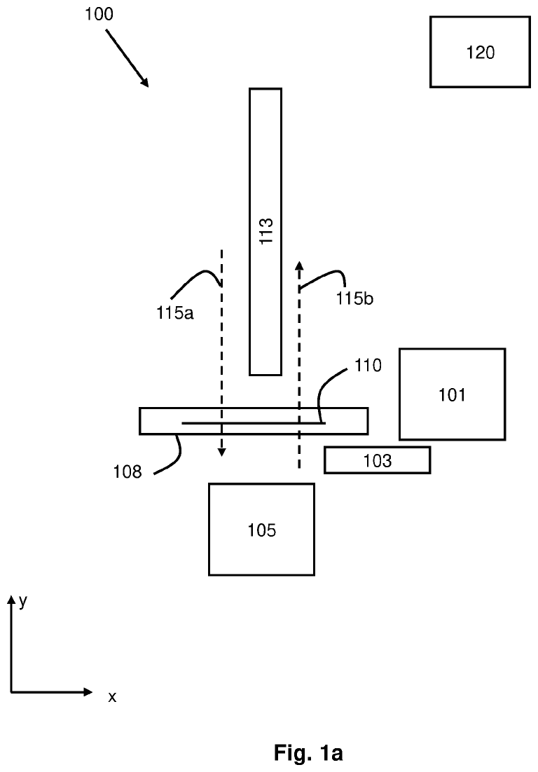

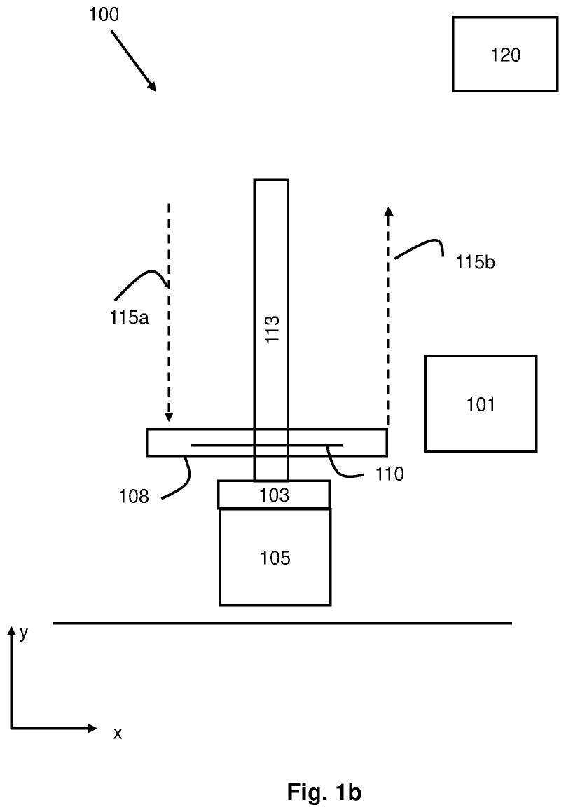

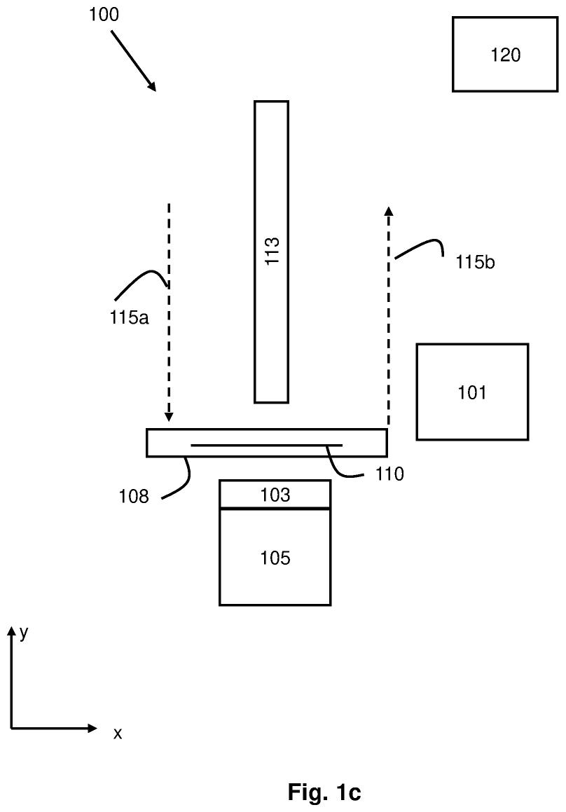

FIG. 1a is a schematic drawing illustrating an applicator arrangement 100. The applicator arrangement 100 comprises or is connected to a label dispenser 101 arranged to dispense one or more labels 103. Prior to being dispensed from the label dispenser 101, a label printer (not illustrated in FIG. 1a) may have printed the label 101 with a print, for example a bar code, an expiry date, shipping information, just to mention some examples. The label printer can be either integrated in the label dispenser or be separate in which case the label dispenser simply dispenses pre-printed labels. The label 103 may be described as an information carrier media. The label 103 may be made of any suitable type of materials, depending on the specific requirements and application. Some example materials used for labels 103 may for example be paper, synthetic materials, cardstock, clear and transparent materials, thermal labels, and specialty materials. The label 103 may be of any suitable size and shape. The label dispenser 101 is arranged to run at a dispenser speed when dispensing the label 103. The label 103 travels at the dispenser speed as long as it is contact with the label dispenser 101, i.e. before it is detached from the label dispenser 101. The dispenser speed may be a first speed, a feed speed, a print speed etc.

The label 103 has a first side and a second side which are opposite to each other. The first side may be a front side and the second side may be a back side. The first side may be a non-sticky side and the second side may be a sticky side. The print may be located on the first side of the label 103. At least part of the second side of the label 103 may be covered by an adhesive material and a backing paper may cover the adhesive material.

The sticky side may be described as being sticky because it is at least partly covered by an adhesive material, i.e. a sticky material. The backing paper is removed before applying the label 103 to an object 105, typically during the stage of dispensing the label 103 from of the dispenser 101. Multiple labels 103 protected by backing paper may be rolled up on a roll in the dispenser 101. In some cases, labels can be made up of multiple layers and have tear off sections. Some labels may contain the box content and then on top the shipping data. In some application linerless labels, i.e. labels without backing paper may also be used, whereas peel off operation of the label from the backing paper is eliminated.

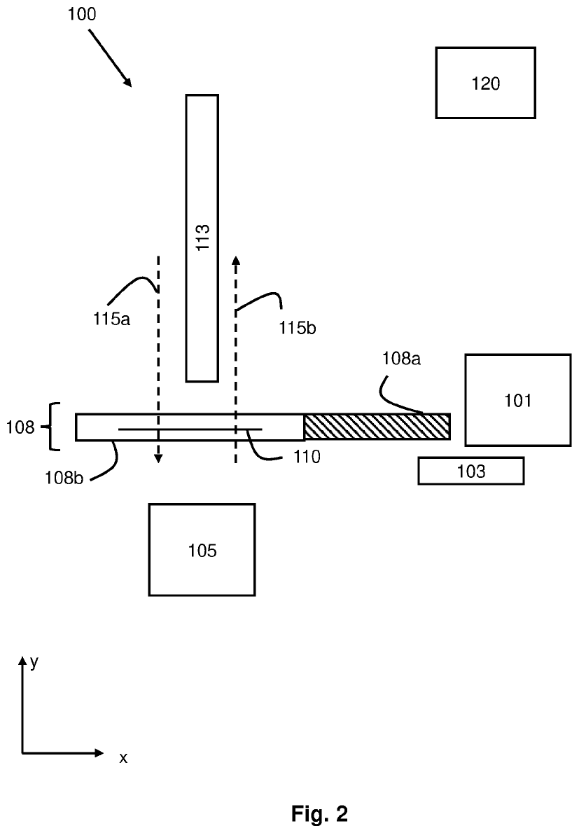

The applicator arrangement 100 comprises a label holder 108 arranged to hold the label 103 after it has been dispensed from the label dispenser 101. Using other words, the label holder 108 obtains the label 103 from the label dispenser 101. The label holder 108 may have first side and a second side. The first side of the label holder 108 may be described as facing the label applicator 113, and the second side of the label holder 108 may be described as the side on which the label 103 may be held. The second side of the label holder 108 faces the object 105 on which the label 103 is to be applied. In other words, the label 103 may be described as being held on the underside of the label holder 108, and the upper side of the label holder 108 faces the label applicator 103. The label holder 108 may be a label conveyor, or the label holder 108 may comprise a label conveyor. The label holder 108 may be arranged to hold and convey the label 103. Conveying the label 103 may comprise to transport or move the label 103 from one position to another position. The label holder 108 is arranged to hold the label 103 by means of under pressure created by for example a fan, a vacuum device or similar. The under pressure prevents the label 103 from falling down to the ground after it has been applied to the label holder 108. The label holder 108 is arranged to run in a first conveyor speed and/or a second conveyor speed, which will be described in more detail with reference to FIG. 2.

The label holder 108 comprise an opening 110. The opening 110 may be referred to as a slit, a gap, a hole, a cut through etc. The opening 110 may cover the whole length of the label holder 108 such that it splits the label holder 108 in two parts, or it may cover a part of the length of the label holder 108.

The applicator arrangement 100 comprises a label applicator 113. The label applicator 113 is arranged to apply the label 103 to the object 105. At least part of the label applicator 113 is arranged to run through the opening 110. Thus, the opening 110 may have a size and shape which is such that at least part of the applicator 113 can run through it, for example such that an applicator pad comprised in the label applicator (not shown in FIG. 1a) can run through the opening 110. The opening 110 may also have a size and shape which is such that at least part of the label 103 will extend over the opening against the underside of the label holder 108.

At least part of the label applicator 113 is arranged to run through the opening 110. At least part of the label applicator 113 is arranged to move in a first direction 115a and in a second direction 115b which are opposite to each other. The first direction 115a may be described as a direction down through the opening 110 and the second direction 115b may be described as a direction up through the opening 110. The first direction 115 and the second direction 115b may be described as a vertical direction which corresponds to the y-axis in the coordinate system illustrated in FIG. 1a. The x-axis of the coordinate system illustrated in FIG. 1a corresponds to a horizontal direction and may be the direction in which the label holder 108 is arranged. Consequently, the x-axis of the coordinate system illustrated in FIG. 1a corresponds to a horizontal direction and may be the direction in which the label 103 has when it is held by the label holder 108 the first side of the label 103 is facing away from the label holder 108 and the second side of the label 103 is facing towards the label holder 108. Thus, at least part of the label applicator 113 may be arranged to move in a direction which is substantially perpendicular to the direction in which the label holder 108 is arranged.

The label applicator 113 is arranged to move towards the label 103 which is held by the label holder 108, touch or hit the label 103 after the label applicator 113 has moved through the opening 110 and finally apply the label 103 onto the object 105. The label may be hold in places by the label holder 108 using a suitable technique, such as (but not limited to) gravity, suction, vacuum, opposite charge, etc.

FIG. 1a illustrates the label applicator 113 when it is in a storage position. When the label applicator 113 is in the storage position, the label holder 108 is located between the label applicator 113 and the object 105. The label applicator 113 is in the storage position before the label 103 is applied to the object 105.

FIG. 1b is a schematic drawing illustrating that the label applicator 113 is in an apply position. When the label applicator 113 is in the apply position, at least a part of the label applicator 113 has run through the opening 108. The label 103 is located between the second side of the label holder 108 and the object 105 when the label applicator 113 is in the apply position. The label applicator 113 is in the apply position when it has moved in the first direction 115a and applies the label 103 to the object 105.

FIG. 1c is a schematic drawing illustrating that the label applicator 113 is in the storage position after the label 103 has been applied to the object 105. When the label applicator 113 is in the storage position, the label holder 108 is located between the label applicator 113 and the object 105. The label applicator 113 is in the storage position before the label 103 is applied to the object 105. The storage position is the same both before and after the label 103 has been applied to the object 105.

When the label holder 108 has obtained the label 103, at least part of the label applicator 113 is arranged to be triggered to run through the opening 110 in the first direction 115a touch the label 103 after the label applicator 113 has run through the opening 110 and to apply the label 103 to the object 105. Thus, the label applicator 113 moves from the storage position to the apply position.

The at least part of the label applicator 113 is arranged to be triggered to run through the opening 110 in the second direction 115b after the label 103 has been applied to the object 105. Thus, the label applicator 113 moves from the apply position to the storage position.

FIGS. 1a, 1b and 1c illustrates a control unit 120. The control unit 120 is arranged to control the applicator arrangement 100. The control unit 120 is arranged to be connected to one or more components of the applicator arrangement 100 via a wireless communication link, a wired communication link or a combination of a wireless and wired communication link. The control unit 120 comprises for example a processing circuitry, a memory, a transmitter, a receiver etc. The control unit 120 will be described in more detail later.

FIG. 2 is a schematic drawing illustrating the applicator arrangement 100. FIG. 2 illustrates that the label holder 108 is a label conveyor or comprises a label conveyor. FIG. 2 illustrates that the label holder 108 may comprise a first section 108a followed by a second section 108b. The first section 108a is illustrated with a shaded rectangle in FIG. 2. The label holder 108 may be described as a label conveyor, a dual section label transportation conveyor, a label transportation conveyor or similar. The second section 108b comprises the opening 110. As mentioned earlier, the size and shape of the opening 110 is such that that at least part of the label applicator 113 may run through it. The label holder 108 may be arranged to obtain a first label 103 from the label dispenser 101 at the dispenser speed and convey the first label 103 on the first section 108a. The first label 103 runs at the dispenser speed as long as the first label 103 is in contact with the label dispenser 101. When the first label 103 is detached from the label dispenser 101, then the first label 103 may be conveyed on the first section 108a of the label holder 108 at a first conveyor speed. The first conveyor speed may be the same as the dispenser speed or it may be higher than the dispenser speed. When the first label 103 has reached the second section 108b, at least part of the label applicator 113 is arranged to be triggered to run through the opening 110 in the first direction 115a such that the label applicator 113 touches the first label 103 after it has run through the opening 110 and applies the first label 103 to the object 105.

The label holder 108 may be arranged to obtain a second label 103 from the label dispenser 101 at the dispenser speed and convey the second label 103 on the first section 108a at the same time as the first label 103 is applied to the object 105. The second label 103 runs at the dispenser speed as long as the first label 103 is in contact with the label dispenser 101. When the second label 103 is detached from the label dispenser 101, then the second label 103 may be conveyed on the first section 108a of the label holder 108 at the first conveyor speed. The first conveyor speed may be the same as the dispenser speed or it may be higher than the dispenser speed. The second label 103 has been obtained from the label dispenser 101 and is held by the first section 108a after the label applicator 113 has run through the opening 110 in the second direction 115b. The label holder 108 may be arranged to convey the second label 103 to the second section 108b at a second conveyor speed after the label applicator 113 has run through the opening 110 in the second direction 115b. The second conveyor speed may be the same as the first conveyor speed or it may be different than the first conveyor speed. The second conveyor speed may be higher than the first conveyor speed, and the first conveyor speed may be higher than the dispenser speed or the same as the dispenser speed. The second conveyor speed and the first conveyor speed may be both higher than the dispenser speed. The first conveyor speed may be a low conveyor speed and the second conveyor speed may be a high conveyor speed. For example, if the first conveyor speed is higher than the dispenser speed, the second label 103 may move at the dispenser speed as long as it is connected to the label dispenser 101. When the second label 103 is detached from the label dispenser 101, the second label 103 may run at the first conveyor speed. Thus, the second label 103 may run at the same speed or a higher speed when it is detached from the label dispenser 101, as compared to when it was connected to the label dispenser. After the label applicator 113 has run through the opening 110 in the second direction 115b, the speed of the label holder 108 may change from the first conveyor speed to the second conveyor speed. If the second conveyor speed is higher than the first conveyor speed, the speed of the label 103 may increase such that the time it takes for the second label 103 to reach the opening 110 is reduced.

As mentioned above, the label holder 108 is arranged to hold the label 103 as it is being transported along the conveyor. The label holder 108 may have a fan or a vacuum device arranged for holding the label 103, i.e. the fan of vacuum device is arranged to create under pressure such that the label 103 may be held by the label holder 108. The label holder 108 is arranged to hold the label 103 at the second side of the label holder 108, i.e. the side which faces the object 105. In other words, the first side of the label 103 faces the label holder 108 and the second side of the label 103, e.g. the sticky side, faces the object 105. This may be described as the label 103 being held on the underside of the label holder 108. The label holder 108 may comprise at least two belts with gaps in between, or the label holder 108 may comprise one or more belts with holes to let air pass. The gap and the holes are representations of the opening 110.

The first section 108a of the label holder 108 is arranged to collect the label 103 as it is being fed onto the label holder 108 from the label dispenser 101. As the conveyor, i.e. the label holder 108, is driven there may be no need to have a label release position. The label holder 108 may transport the label 103 away from the backing paper/liner after it is fed onto the label holder 108. During this procedure the label holder 108 may run at a speed which is close to the dispenser feed speed.

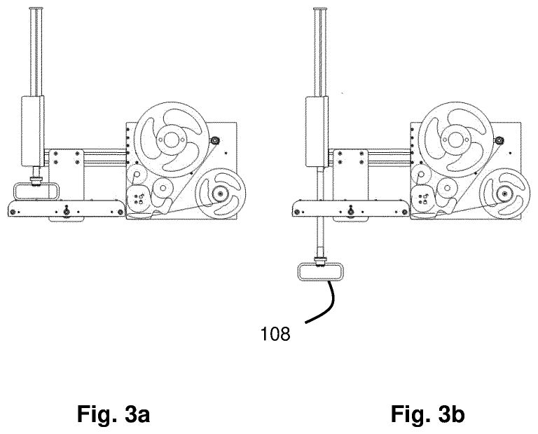

The second section 108b of the label 108b is split to create the opening 110, e.g. a slit, which allows at least a part of the label applicator 113, e.g. a mechanical label fold type label applicator, to run through. The label applicator 113 may comprise an applicator pad, also referred to as an applicator head. When the applicator pad comes back up after an application cycle, i.e. when it moves from the apply position to the storage position, then the next or second label sits ready at the first section 108a of the label holder 108. The label holder 108 then starts fast feeding the next or second label out to the second section 108b of the label holder 108. The label holder 108 may run at the second conveyor speed when fast feeding the next or second label. This fast-feeding cycle is significantly faster than the label dispenser can dispense a label 103, i.e. the second conveyor speed is faster than the dispenser speed. The label applicator 113 can now start applying the second label. At the same time, the second label can be dispensed onto the first section 108a of the label holder 108. The fast feed position is illustrated in FIG. 3a and the apply current print next label position is illustrated in FIG. 3b.

It is also illustrated that the applicator holder is 108 is a substantially rectangular structure, in some embodiments made of a substantially flexible material and connected to the holder arm at its center point. The holder may be made in one piece or a substantially rectangular washer shaped, circumference of tubular material.

The label holder 108 may be held up by a hollow hinge shaft. The drive shaft for the label holder 108 may run inside the hinge shaft. There may be a one way bearing connecting the drive shaft to the hinge shaft. The one-way bearing may run freely in the label feed direction. The hinge shaft may in this position be pushed against a stop position by a spring. When the label holder 108 is activated in the opposite direction it may overcome the spring force and start moving away from the stop position towards a label change position.

A result may be that the total cycle time gets limited by the fast feed time+apply time compared to print time+apply time in a prior art print and apply applicator arrangement. For logistics applications with label application from the top onto boxes of varying heights, the throughput improvement could be as high as around 80%. The figures could be as follows:

For example, a shipping label is 210 mm long. It normally takes about 1 s to print such a label. If the difference between the lowest and highest box is 1000 mm then the maximum application distance may be set to be 1150 mm to create some margin. If the label applicator speed is 3000 mm/s, then one label application cycle also takes about 1 s. The total cycle time is 1+1=2 s. The maximum throughput is then 60 (s/min)/2 (s/box)=30 boxes/min.

With the present disclosure, the maximum total throughput is limited by the fast feed time+the label application time. Recall that the fast feed time is also referred to as the second speed. The fast feed time is around 0.13 s for a 210 mm long label if the peak speed is 3000 mm/s. The next label is printed when the label applicator 113 applies the previous label. In this case the minimum cycle time is thus: print time+fast feed time=1 s+0.13 s=1.13 s. The maximum throughput is now 60 (s/min)/1.13 (s/box)=53.1 boxes/min. The performance gain in this case is=53.1(boxes/min)/30(boxes/min)=1.77=77%.

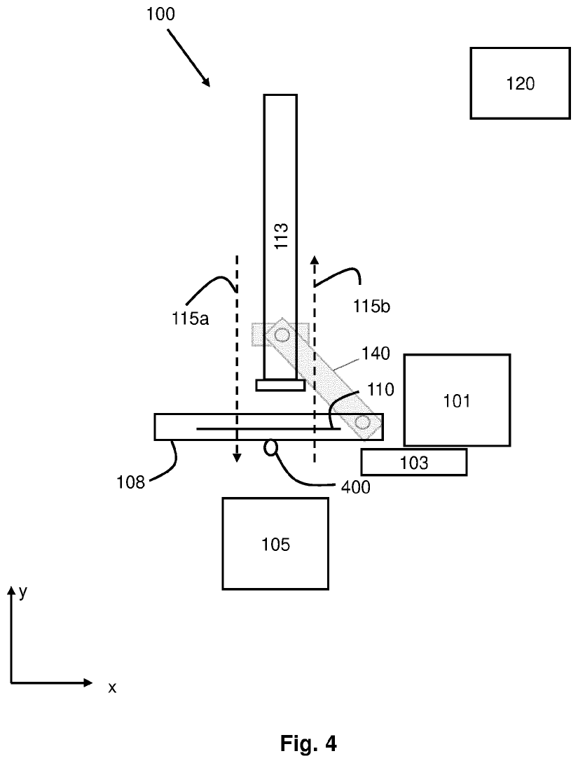

FIG. 4 is a schematic drawing illustrating an applicator arrangement 100. FIG. 4 illustrates that the label holder 108 is arranged to hingedly move around a center point 400. Using other words, the label holder 108 is arranged to tilt around the center point 400. The center point 400 may be located substantially at the center of the label holder 400. The label holder 108 is arranged to hingedly move around the center point 400 when changing between a feed position 501 and a label release position 502. A part of the label holder 108 that is closest located to the label dispenser 101 is arranged to be moved downwards in the first direction 115a when moving from the feed position 501 to the label release position 502. When the label holder 108 is in the label release position 502, the label applicator 113 is arranged to run through the opening 110 in the first direction 115a, touch the label 103 after the label applicator 113 has through the opening 110 and to apply the label 103 to the object 105. When the label holder 108 is arranged to hingedly move around the center point 400, the cost is reduced as no extra motor in needed to control the position of the label holder 108. The label applicator 113 may be arranged to move the label holder 108 around the center point 400 by pushing the label holder 108. When the label applicator 113 moves the label holder between the feed position 501 and the label release position 502, the label holder 108 may be hinged further away from the label dispenser 101 than the label applicator 113.

In the above example the point 400 is arranged substantially in a center point, however, in other exemplary embodiments the center point 400 can be located so that a rotation of the label holder 108 is achieved. This rotation is created when the applicator 113 is in a loop or bracket 140 and lifts the label holder to position 502 and 503. The center point in this case can be located in such a way to create a lever and a rotational torque in the label holder. This implies that the point of rotation need not to be in the center of the applicator. This negates the need for a separate motor for the rotation of the label holder.

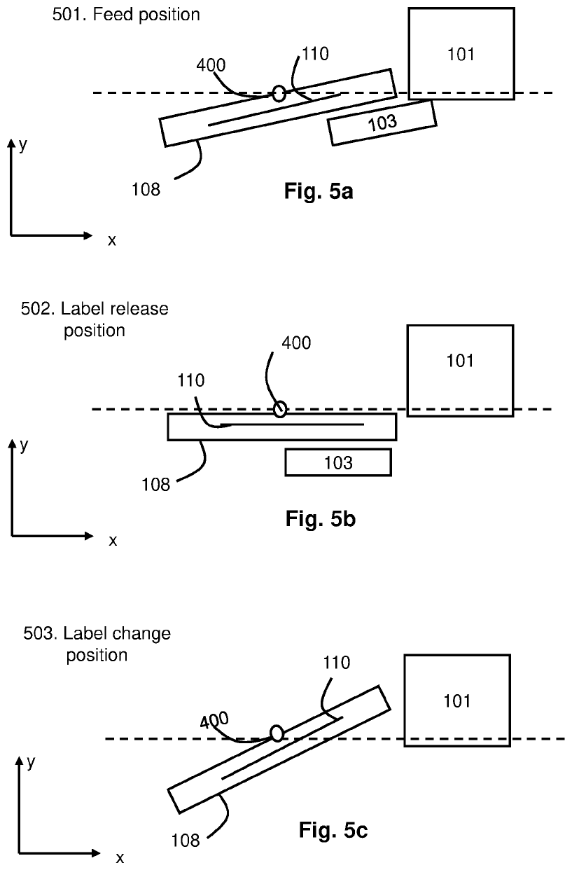

FIG. 5a illustrates the feed position 501. The label holder 108 is arranged to be in the feed position 501 when the label 103 is obtained from the label dispenser 101. The feed position 501 may be referred to as a print position. In the feed position 501, the label 103 is easily fed onto the label holder 108. When the label holder 108 is in the feed position 501, the part of the label holder 108 that is closes to the label dispenser 101 is tilted upwards towards the label dispenser 101, where upwards is the same as the second direction 115b. Note that for the application arrangement 100 exemplified in FIG. 2, the feed position 501 is substantially horizontal, where horizontal corresponds to the x-axis in the coordinate system shown in FIG. 5a.

FIG. 5b illustrates the label release position 502. The label holder 108 is arranged to be in a label release position 502 when a backing paper is released from the label 103 and when the label 103 is being applied to the object 105. At the label release position 502, the label 103 may snap away and release from the backing paper at the end of the print cycle. The position 502 should be different to position 501 in order to move the label away from the backing paper. Position 502 could be a short distance (e.g., some mm) below 501 with respect to the plane of the drawings.

FIG. 5c illustrates a label change position 503. At the label change position 503, new labels 103 are loaded onto the label holder 108. The label change position 503 allows for easy access to print related parts like the printhead or print/drive roller. When the label holder 108 is in the label change position 503, it may be in the same position as when it is in the feed position 501. When the label holder 108 is in the label change position 503, the part of the label holder 108 that is closes to the label dispenser 101 is tilted upwards towards the label dispenser 101, where upwards is the same as the second direction 115b.

The label holder 108 may be hinged around the center point 400 and the part closest to the label dispenser 101 may be pushed down by a passive component such as a spring or by one or more magnets. The lowest position is the label release position 502 which may be defined by a mechanical stop. The label holder 108 may be equipped with a loop or bracket 140 (FIG. 4) that catches the label applicator 113 on its way up in the second direction 115b. The lower part of the label applicator 113 is above the label 103 when the label applicator 113 is trapped by the loop.

When the label applicator 113 continues up in the second direction 115b, then the label holder 108 may be moved to the feed position 501. In order to get accuracy in this position the label applicator 113 may be controlled in a precise way.

When the label applicator 113 continues further up in the second direction 115b, it reaches the label change position 503.

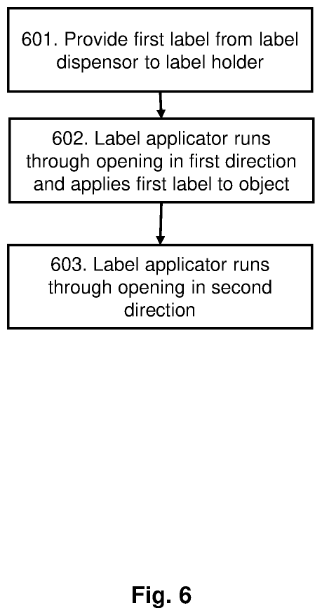

A method for enabling the label 103 to be applied to the object 105 will now be described with reference to the flow chart in FIG. 6. The method may be performed by the control unit 120 or a computer system comprising a processing circuitry. The method comprises at least one of the following steps, which steps may be performed in any suitable order than described below:

### Step 601

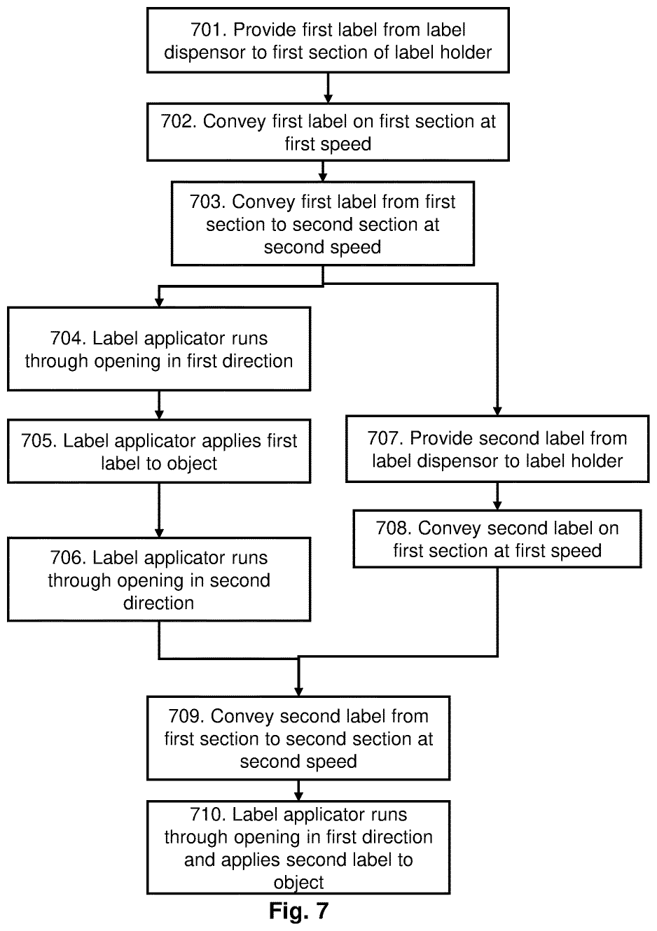

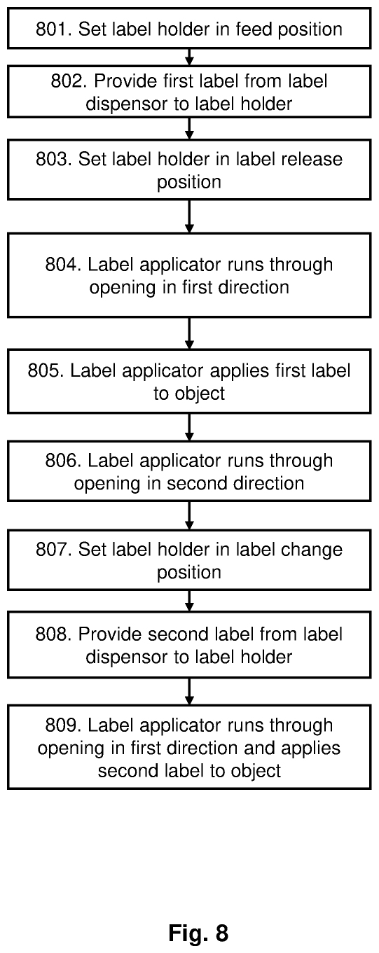

This step corresponds to step 701 in FIG. 7 and step 802 in FIG. 8. The control unit 120 triggers a first label 103 to be provided from a label dispenser 101 to a label holder 108. The first label 103 is dispensed from the label dispenser 101 at the dispenser speed. The first label 103 is located on and held by the label holder 108 after it has been detached from the label dispenser 101.

### Step 602

This step corresponds to steps 703 and 704 in FIG. 7 and steps 804 and 805 in FIG. 8. When the label holder 108 has obtained the first label 103, the control unit 120 triggers at least a part of a label applicator 113 to run through an opening 110 comprised in the label holder 108 such that the label applicator 113 touches the first label 103 after it has run through the opening 110 and then applies the first label 103 to the object 105.

The label holder 108 may be arranged to hold the first label 103 by means of a fan or a vacuum device.

### Step 603

This step corresponds to step 705 in FIG. 7 and step 806 in FIG. 8. The control unit 120 triggers at least a part of the label applicator 113 to run through the opening 110 in the second direction 115b after the first label 103 has been applied to the object 105. The second direction 115b is opposite to the first direction 115a. Thus, after the first label 103 has been applied to the object 105, the at least part of the label applicator 113 changes movement direction and moves up through the opening 110 in the second direction 115b, where up is the same as the second direction 115b.

After the first label 103 has been applied to the object 105, a second label 103 may be applied to a second object.

The method in FIG. 6 may be iterated, and the number of iterations may correspond to the number of objects 105 to be applied.

A method for enabling the label 103 to be applied to the object 105 will now be described with reference to the flow chart in FIG. 7 and in view of the applicator arrangement 100 illustrated in FIG. 2. The method may be performed by the control unit 120 or a computer system comprising a processing circuitry. The method comprises at least one of the following steps, which steps may be performed in any suitable order than described below:

### Step 701

The control unit 120 triggers a first label 103 to be provided from a label dispenser 101 to the first section 108a of the label holder 108. The label dispenser 101 runs at a dispenser speed when dispensing the first label 103. The first label 103 travels in the dispenser speed as long as it is contact with the label dispenser 101. The first label 103 is located on and held by the first section 108a of the label holder 108 after the first label 103 has been detached from the label dispenser 101.

The label holder 108 may be arranged to hold the first label 103 by means of a fan or a vacuum device. This prevents the first label 103 from falling to the ground.

### Step 702

The control unit 120 triggers the first section 108a of the label holder 108 to run at a first conveyor speed and to covey the first label 103 on the first section 108a at the first speed. This may happen only after the first label 103 has been detached from the label dispenser 101.

The first speed may be the same as the dispenser speed of the label dispenser 101, or it may be higher than the dispenser speed.

### Step 703

The control unit 120 triggers the second section 108b of the label holder 108 to convey the first label 103 to the second section 108b at a second conveyor speed after the label applicator 113 has run through the opening 110 in the second direction. The second speed may be higher than the first conveyor speed, or it may be the same as the first conveyor speed.

### Step 704

The control unit 120 triggers at least a part of a label applicator 113 to start moving in the first direction 115a and to touch the first label 103 after it has run through the opening 110 in the first direction 115a.

### Step 705

The control unit 129 triggers the at least part of the label applicator 113 to apply the first label 103 to the object 105. Consequently, the first label 103 is applied to the object 105.

### Step 706

The control unit 120 triggers at least a part of the label applicator 113 to run through the opening 110 in the second direction 115b after the first label 103 has been applied to the object 105. The second direction 115b is opposite to the first direction 115a.

### Step 707

The control unit 120 triggers a second label 103 to be provided from the label dispenser 101 to the first section 108a of the label holder 108 at the dispenser speed.

Consequently, the second label 103 is located on and held by the first section 108a of the label holder 108. The label dispenser 101 runs at a dispenser speed when dispensing the second label 103. The second label 103 travels in the dispenser speed as long as it is contact with the label dispenser 101.

The label holder 108 may be arranged to hold the second label 103 by means of a fan or a vacuum device.

### Step 708

The control unit 120 triggers the first section 108a of the label holder 108 to run at a first conveyor speed and to covey the second label 103 on the first section 108a at the first conveyor speed. The first section 108a is triggered to run at the first conveyor speed after the second label 103 has been detached from the label dispenser 101.

Consequently, the control unit 102 first needs to determine that the second label 103 has been detached from the label dispenser 101, for example by obtaining information from the label dispenser 103 indicating that the second label 103 has been detached, by a sensor arranged to detect that the second label 103 has been detached or by any other suitable mans.

The first conveyor speed may be the same as the dispenser speed, or it may be higher than the dispenser speed.

Steps 707 and 708 may be performed at the same time as the first label 103 is applied to the object 105, i.e. at the same time as step 705 is performed.

The first label 103 and the second label 103 may be conveyed in a horizontal direction and the label applicator 113 may move in a vertical direction.

### Step 709

The control unit 120 triggers the second section 108b of the label holder 108 to convey the second label 103 to the second section 108b at a second conveyor speed after the label applicator 113 has run through the opening 110 in the second direction. The second speed may be higher than the first conveyor speed, or it may be the same as the first conveyor speed.

The second conveyor speed may be higher than the first conveyor speed, and the first conveyor speed may be higher than the dispenser speed or the same as the dispenser. The second conveyor speed and the first conveyor speed may be both higher than the dispenser speed. The first conveyor speed may be a low conveyor speed and the second conveyor speed may be a high conveyor speed. For example, if the first conveyor speed is higher than the dispenser speed, the second label 103 may move at the dispenser speed as long as it is connected to the label dispenser 101. When the second label 103 is detached from the label dispenser 101, the second label 103 may run at the first conveyor speed. Thus, the second label 103 may run at the same speed or a higher speed when it is detached from the label dispenser 101, as compared to when it was connected to the label dispenser. After the label applicator 113 has run through the opening 110 in the second direction 115b, the speed of the label holder 108 may change from the first conveyor speed to the second conveyor speed. If the second conveyor speed is higher than the first conveyor speed, the speed of the label 103 may increase such that the time it takes for the second label 103 to reach the opening 110 is reduced.

### Step 710

The control unit 120 triggers at least a part of a label applicator 113 to run through an opening 110 comprised in the label holder 108 such that the label applicator 113 touches the second label 103 after it has run through the opening 110 and applies the second label 103 to the object 105.

The method in FIG. 7 may be iterated, and the number of iterations may correspond to the number of objects 105 to be applied. After the first label and the second label have been applied to a respective object, a third and more labels may be applied.

A method for enabling the label 103 to be applied to the object 105 will now be described with reference to the flow chart in FIG. 8 and in view of the applicator arrangement 100 illustrated in FIGS. 4, 5a, 5b and 5c. The method may be performed by the control unit 120 or a computer system comprising a processing circuitry. The method comprises at least one of the following steps, which steps may be performed in any suitable order than described below:

### Step 801

The control unit 120 triggers the label holder 108 to enter the feed position 501.

### Step 802

The control unit 120 triggers a first label 103 to be provided from a label dispenser 101 to the label holder 108 at a dispenser speed. Consequently, the first label 103 is located on and held by the label holder 108.

The label holder 108 may be arranged to hold the first label 103 by means of a fan or a vacuum device.

The backing paper of the label 103 may have been removed from the first label 103 before it is held by the label holder 108.

### Step 803

The control unit 120 triggers the label holder 108 to enter the label release position 502.

### Step 804

The control unit 120 triggers at least a part of a label applicator 113 to start moving in the first direction 115a and to touch the first label 103 after it has run through the opening 110 in the first direction 115a.

### Step 805

The control unit 129 triggers the at least part of the label applicator 113 to apply the first label 103 to the object 105. Consequently, the first label 103 is applied to the object 105.

### Step 806

The control unit 120 triggers at least a part of the label applicator 113 to run through the opening 110 in the second direction 115b after the first label 103 has been applied to the object 105. The second direction 115b is opposite to the first direction 115a When the at least part of the label applicator 113 runs in the second direction 115b or after the at least part of the label applicator 113 has run in the second direction 115b for a certain amount of time, the at least part of the label applicator 113 may be caught by a loop. The loop may be a stop device. The loop prevents the at least part of the label applicator 113 to move further in the second direction 115b. The loop catches the label applicator 113 on its way up through the opening 110 in the second direction 115b.

### Step 807

The control unit 120 triggers the label holder 108 to enter the label change position 503.

The control unit 120 triggers the label holder 108 to move from the label release position 502 to a label change position 403 when the first label 103 has been applied to the object 105. The part of the label holder 108 that is closest located to the label dispenser 101 may be arranged to be moved upwards in the second direction 115b when moving from the label release position 502 to the label change position 503.

### Step 808

The control unit 120 triggers the label holder 108 to enter the label release position 502.

The control unit 120 triggers a second label 103 to be provided from the label dispenser 101 to the label holder 108 at the dispenser speed. The second label 103 is located on and held by the label holder 108 after it has been detached from the label dispenser 101.

The label holder 108 may be arranged to hold the second label 103 by means of a fan or a vacuum device.

The backing paper of the label 103 may have been removed from the second label 103 before it is held by the label holder 108.

### Step 809

The control unit 120 triggers at least a part of a label applicator 113 to run through an opening 110 comprised in the label holder 108 such that the label applicator 113 touches the second label 103 after the label applicator 113 has run through the opening 110 and applies the second label 103 to the object 105.

The method in FIG. 8 may be iterated, and the number of iterations may correspond to the number of objects 105 to be applied. After the first label and the second label have been applied to a respective object, a third and more labels may be applied.

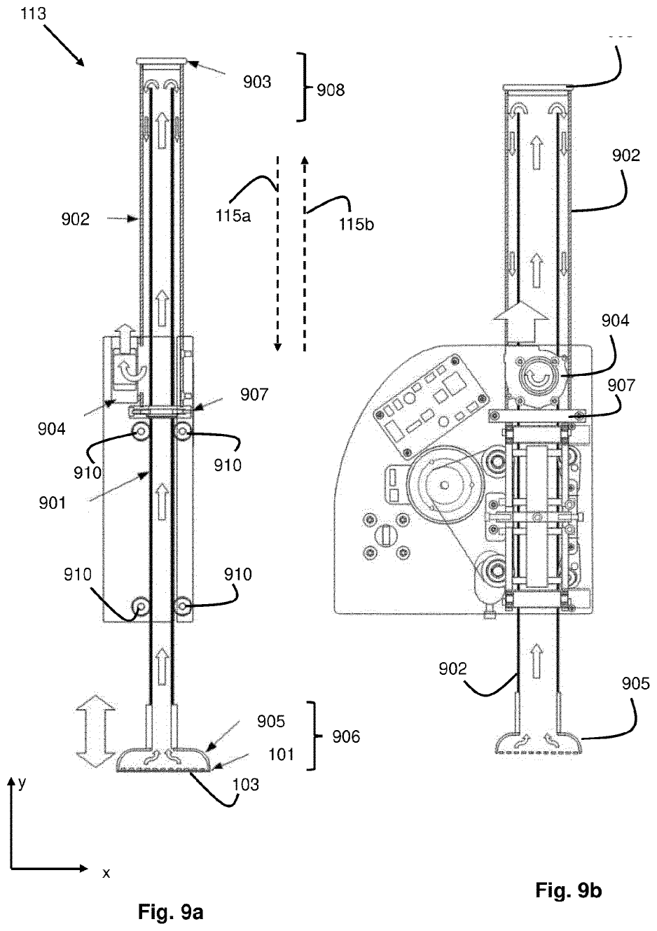

The label applicator 113 will now be described in more detail with reference to FIG. 9a and FIG. 9b. FIG. 9a and FIG. 9b are schematic drawings illustrating the label applicator 113. FIG. 9a illustrates the label applicator 113 from one side and FIG. 9b illustrates the label applicator 113 from another side. The label applicator 113 may be a linear type of label applicator. The label applicator 113 may be a mechanical label fold type label applicator.

The label applicator 113 comprises an outer rod 902 arranged to at least partly encapsulate an inner rod 901. The inner rod 901 is arranged to move in the first direction 115a out of the outer rod 902 and in the second direction 115b into the outer rod 902. The inner rod 901 may be a first rod and the outer rod 902 may be a second rod. The inner rod 901 may be a hollow and electrically actuated rod which is arranged to move the label 103 up and down. The outer rod 902 may be a hollow which is larger than the inner rod 901 and that at least partly encapsulates the inner rod 901 from the main body and up.

The inner rod 901 and the outer rod 902 may have any suitable dimensions. For example, the inner rod 901 may be 1″×1″ or 1″×2″ carbon fiber rod, and the outer rod 902 may be 1″ wider than the inner rod 901 in both directions.

The label applicator 113 comprises an applicator pad 905 arranged to hold the label 103 and to apply the label 103 to the object 105. The applicator pad 905 is arranged at a bottom end 906 of the inner rod 901. The applicator pad 905 may be referred to as an applicator head. More details about the applicator pad 905 will be provided below.

The label applicator 113 may comprise a fan 904 arranged to suck air out from the outer rod 902 thereby enabling the label 103 to be held by the label pad 905. The air that is sucked out is illustrated by the thick white arrows in FIG. 9a and FIG. 9b. The fan 904 may be arranged to be connected to the outer rod 902. The outer rod 902 comprises an air opening through which the fan 904 may withdraw air from the inside of the outer rod 902.

The fan 904 may be arranged to suck or withdraw air out through a hole in the outer rod 902, forcing the air to be taken from the applicator pad 905, by which the label 103 is held.

The outer rod 902 may comprise an end cap 903 arranged at a top end 908 of the outer rod 902. The end cap 903 may be arranged to seal the outer rod 90 at the top. The top end 902 of the outer rod 902 may be at an opposite end of the label applicator 113 compared to the bottom end 906 of the inner rod 901.

The label applicator 113 may comprise a seal 907 arranged between the inner rod 901 and the outer rod 902. The seal 907 may be in the form of one or more brushes.

The label applicator 113 may comprise at least one roller 910 connected to the inner rod 901, and the at least one roller 910 may be arranged to guide the inner rod 901 when moving in and out of the outer rod 902. The label applicator 113 may comprise at least three rollers 910, and each roller 910 may be located on a first side, a second side and a third side of an inside of the outer rod 902, respectively. Thus, the inner rod 901 may be guided by rollers 910 on three sides. The rollers 910 on the first side may be connected through ball bearings to the main body. The rollers 910 on two of the adjacent sides may be connected to a spring-loaded holder through ball bearings.

The label applicator 113 may comprise a friction belt. The friction belt may be arranged on a fourth side of an outside of the outer rod 902. Thus, on the fourth side of the outside of the outer rod 902, the inner rod 902 may be guided by the friction belt, which may be driven by a Brushless Direct Current (BLDC) motor. The friction belt may go by two passive wheels who are connected through ball bearings to the main body. This may give a low and predictable roll resistance as well as a predictable friction between the friction belt and the inner rod 901 even at varying rod and roller dimensions. The spring-loaded design on the two adjacent sides may handle for example changing roller diameters due to wear. The main body mentioned above is the static part to which for example the outer rod 902 and the motor are connected. The two passive rollers used to guide the friction belt are connected through ball bearings directly to the main body. The other rollers are connected to the main body through ball bearings and spring-loaded holders. The friction belt is the timing belt connected to the motor. It is routed around two other rollers and has a high friction back side connected to the inner rod 901, used to drive the inner rod 901 in the first direction 115a and the second direction 115b. This friction drive simplifies the moving inner rod 901. The friction belt may not need extra parts for transmission, adding to the weight and complexity. The spring loaded rollers make sure that the inner rod 901 is pushed against the friction belt with constant force.

The label applicator 113 may comprise or may be connected to a sensor arranged to detect a position of the inner rod 901 in the outer rod 902. The sensor may be a position sensor. The sensor may be a synchronization sensor. The sensor may be arranged to act as media sensors. The sensor may be arranged to synchronize the rod position for example every apply cycle by detecting the top of the rod when passing the sensor. The sensor may be located on the outer rod 902. This sensor detects when the upper edge of the inner rod 901 passes through. This may happen when the inner rod 901 is on the way back to the storage position after a label 103 is applied. This may enable correction for possible slippage between the friction belt and the inner rod 901 that may occur when the inner rod 901 collides with the object 105 which shall be labeled.

The applicator pad 905 will now be described in more detail. The applicator pad 905 may be arranged to mechanically fold the label 103.

The applicator pad 905 may be made of a flexible and compressible material and the applicator pad 905 may comprise a cut out in a center position. This may be in order to compress when the label 103 and label applicator 113 hits the object 105 at high speed. This allows for a smoother application of the label 103 to the object 105 and for the application pad 905 to shape according to an uneven surface. The flexibility in the applicator pad 905 also reduces the risk that the applicator pad 905 gets stuck in the object 105. It is more likely that it will just flex and fold away, allowing the object 105 to continue. The flexible and compressible material may be for example rubber or polyurethane.

A first side of the applicator pad 905 may be arranged to be connected to the bottom end of the inner rod 901 and a second side of the applicator pad 905 may be arranged to face and/or touch the label 103. The second side of the applicator pad 905 may have a size and shape such that it is arranged to create a fold along a center of the label 103 when the applicator pad 905 touches the label 103 after the applicator pad 905 has run through the opening 110. The applicator pad 905 is arranged to touch the first side of the label 103, e.g. the non-sticky side of the label 103.

The material that the applicator pad 905 is made of may have a fairly high friction and its narrow side may be reasonable flat. This ensures that the label 103 does not slip when it is pushed away from the holding force (for example vacuum or suction) holding the label 103 on the label holder 108.

The wide underside of the applicator pad 905 may be wide enough and straight enough to create a straight fold along approximately the center of the label 103, making the label shape like a “U” in the air.

The applicator pad 905 may comprise a disconnecting device arranged to disconnect the applicator pad 905 from the object 105. The disconnecting device may comprise a snap off function, and it may comprise, for example magnets. If the applicator pad 905 gets stuck despite the flexibility in the material and design, then the applicator pad 905 may snap away and allow the label applicator 113 to retract back to its storage position.

The label applicator 113 may comprise a detector arranged to detect that the label 103 has hit the object 105 and that the applicator pad 905 has been compressed. The label applicator 113 may be arranged to stop a movement towards the object 105 when the compression has been detected.

The movement of the label applicator 113 may be controlled, e.g. by the control unit 120, in a way that detects when the label 103 has hit the object 105 and the applicator pad 905 is starting to compress may for example be done by measuring the current consumed by the drive motor and the label applicator speed. With a speed control design, the drive current may be expected to go up during compression. With a current control design, the speed may be expected to go down during compression. A combination of the two may also be possible.

When compression is detected, the label applicator 113 stops and goes back home to the storage position. The label 103 may unfold according to the surface shape of the object 105.

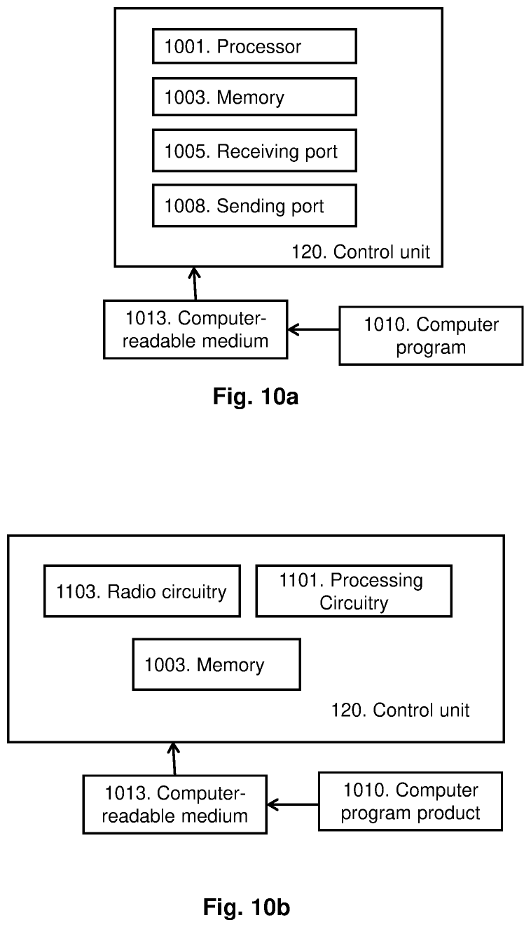

To perform the method described herein, e.g. as illustrated in FIGS. 6, 7 and 8, the control unit 120 may comprises an arrangement as shown in FIG. 10a and/or FIG. 10b. FIG. 10a and FIG. 10b illustrates two different examples of the arrangement that the control unit may comprise.

The present method performed by the control unit 120 may be implemented through one or more processors, such as the processor 1001 in FIG. 10a together with computer program code for performing the functions and actions described herein. A processor, as used herein, may be understood to be a hardware component. The program code mentioned above may also be provided as a computer program product, for instance in the form of a data carrier carrying computer program code for performing the present disclosure when being loaded into control unit 120. One such carrier may be in the form of a CD ROM disc. It is however feasible with other data carriers such as a memory stick. The computer program code may be provided as pure program code on a server and downloaded to the control unit 120.

The control unit 120 may comprise a memory 1003 comprising one or more memory units. The memory 1003 is arranged to be used to store obtained information, store data, configurations, scheduling, and applications etc. to perform the methods herein when being executed in the control unit 120.

The control unit 120 may receive information through a receiving port 1005. The control unit 120 may receive information from another device, unit etc. through the receiving port 1005. Since the receiving port 1005 may be in communication with the processor 1001, the receiving port 1005 may then send the received information to the processor 1001. The receiving port 1005 may also be configured to receive other information.

The processor in the control unit 120 may be configured to transmit or send information through a sending port 1008, which may be in communication with the processor 1001 and the memory 1003.

Thus, the methods described herein may be respectively implemented by means of a computer program product 1010, as illustrated in FIG. 10b, comprising instructions, i.e., software code portions, which, when executed on at least one processor 1001, cause the at least one processor to carry out the actions described herein, as performed by the control unit 120. The computer program product 1010 may be stored on a computer-readable storage medium 1013. The computer-readable storage medium 1013, having stored thereon the computer program 1010 may comprise instructions which, when executed on at least one processor, cause the at least one processor to carry out the actions described herein, as performed by the control unit 120. The computer-readable storage medium 1010 may be a non-transitory computer-readable storage medium, such as a CD ROM disc, or a memory stick. The computer program product 1010 may be stored on a carrier containing the computer program just described, wherein the carrier is one of an electronic signal, optical signal, radio signal, or the first computer-readable storage medium, as described above.

The control unit 120 may comprise a communication interface configured to facilitate communications between the control unit 120 and other devices or another structure. The interface may comprise a transceiver configured to transmit and receive radio signals over an air interface in accordance with a suitable standard.

The control unit 120 may comprise a processing circuitry 1101, e.g., one or more processors such as the processor 1001. The control unit 120 may also comprise a radio circuitry 1103, which may comprise e.g., the receiving port 1005 and the sending port 1008. The processing circuitry 1101 may be configured to, or operable to, perform the method described herein. The radio circuitry 1103 may be configured to set up and maintain at least a wireless connection with the control unit 120. Circuitry may be understood herein as a hardware component.

Hence, the present disclosure also relates to the control unit 120 operative to operate in the applicator arrangement 100. The control unit 120 may comprise the processing circuitry and the memory. The memory comprises instructions executable by said processing circuitry. The control unit 120 is operative to perform the actions described herein in relation to the control unit 120.

A computer program product comprises program code for performing, when executed by a processing circuitry, the method described herein.

A non-transitory computer-readable storage medium comprises instructions, which when executed by a processing circuitry, cause the processing circuitry to perform the method described herein.

Some embodiments described herein may be summarised in the following manner:

A linear type of label applicator may comprise one or more of the following:
a hollow and electrically actuated rod;
an inner rod;
a second hollow rod encapsulating the inner rod;
an outer rod;
an end cap;
a sealing;
a fan device;
an applicator pad;

The hollow and electrically actuated rod is configured to move the label up and down. The second hollow rod encapsulates the inner rod from the main body and up. The end cap seals the outer rod at the top. The sealing is added between the two rods at the main body. The fan device is arranged to suck air out through a hole in the outer rod, forcing the air to be taken from the applicator pad, arranged for holding the label.

A label holder 108 of an applicator arrangement 100 is provided, wherein the label holder 108 is hinged around a center point and a part closest to the label dispenser 101 is pushed down by means of a passive component, such as a spring or a one or more magnets, whereby a first position, i.e. a lowest position, is a label release position 502, which is defined by a mechanical stop. The label holder 108 may further comprises a loop that catches the applicator pad 905 on its way up and the lower part of the applicator pad 905 is above the label 103 when the applicator pad 905 gets trapped by the loop, such that when the applicator pad 905 continues up the label holder 108 is moved to the feed position 501 and when the label applicator 113 continues further up it reaches the label change position 503.

A label applicator 113 for mechanically folding a label before application is provided. The label applicator 113 comprises an applicator pad 905 which may be made of a flexible material and may comprise a cut out in the center in order to compress when the label 103 and applicator pad 905 hits the object at high speed. The material may have fairly high friction and the narrow side may be substantially flat. The wide underside of the applicator pad 905 is wide enough and straight enough to create a straight fold along approximately the center of the label 103, forming the label 103 to a substantially U shape before the application to the object 105 and the label applicator 113 may further comprise a snap off function, e.g. comprising magnets. The substantially flat surface of the applicator pad 905 may be a consequence if the applicator pad 905 is cut, for example water or laser.

The applicator arrangement may comprise
a label holder 108, e.g. a dual section label transportation conveyor; and
a label applicator 113, e.g. a mechanical label fold type label applicator.

The label holder 108 is configured to hold, e.g. by suction or vacuum, the label 103 as it is being transported along the label holder 108. The label holder 108 comprises one or several belts with gaps in between or one or more belts with holes to let air pass. The label holder 108 comprising a first section 108a to collect the label 103 as it is being fed onto the label holder 108, a second section 108b of the label holder 108 is split to create a slit in the where the label applicator 113 runs through

When the label applicator 113 is retracted after an application cycle the next label sits ready at the first section 108a of the label holder 108 and the label holder 108 then starts fast feeding the label 103 out to the second/split section 108b of the label holder 108.

The label holder 108 is held up by a hollow hinge shaft, whereby the drive shaft for the label holder 108 runs inside the hinge shaft and comprising a one way bearing connecting the drive shaft to the hinge shaft, the one-way bearing runs freely in the label feed direction. The hinge shaft is in this position pushed against a stop position by a spring. When the label holder 108 is activated in the opposite direction it will overcome the spring force and start moving away from the stop position towards a label change position.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step.

In general, the usage of “first”, “second”, “third”, “fourth”, and/or “fifth” herein may be understood to be an arbitrary way to denote different elements or entities and may be understood to not confer a cumulative or chronological character to the nouns they modify, unless otherwise noted, based on context.

The present disclosure is not limited to the above. Various alternatives, modifications and equivalents may be used. Therefore, disclosure herein should not be taken as limiting the scope. A feature may be combined with one or more other features.

The term “at least one of A and B” should be understood to mean “only A, only B, or both A and B.”, where A and B are any parameter, number, indication used herein etc.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

The term “configured to” used herein may also be referred to as “arranged to”, “adapted to”, “capable of” or “operative to”.

The steps of the methods may be performed in another order than the order in which they appear herein.

1. An applicator arrangement comprising:
a label applicator configured to apply a label to an object; and
a label holder configured to hold the label, wherein the label holder comprises an opening;
wherein at least part of the label applicator configured to:
pass through the opening of the label holder in a first direction, so as to (i) touch the label held by the label holder when the label extends at least partly over the opening and (ii) apply the label to the object; and
pass through the opening in a second direction that is opposite to the first direction.

2. The applicator arrangement according to claim 1,
wherein the label holder comprises a label conveyor,
wherein the label holder comprises a first section and a second section, and wherein the second section comprises the opening;
wherein the label holder is configured to receive the label from a label dispenser at a dispenser speed and to convey the label on the first section; and
wherein the label holder is configured to convey the label, at a conveyor speed that is higher than the dispenser speed, from the first section of the label holder to an apply position on the second section of the label holder in which the label at least partly extends over the opening.

3. The applicator arrangement according to claim 2, wherein the label is a first label;
the label holder is configured to receive a second label from the label dispenser at the dispenser speed and to convey the second label on the first section as the first label is applied to the object from the apply position; and
the label holder is configured to hold the second label on the first section after the label applicator has passed through the opening in the second direction.

4. The applicator arrangement according to claim 1, wherein the label holder is configured to hold the label using a fan or a vacuum device.

5. The applicator arrangement according to claim 2, wherein the conveyor speed is a first conveyor speed, and the label holder is configured to convey the label on the first section at a second conveyor speed, which is lower than the first conveyor speed used to convey the label from the first section to the apply position on the second section.

6. The applicator arrangement according to claim 1, wherein the label holder supported by a hollow shaft, and a drive shaft of the label holder is configured to run inside the hollow shaft.

7. The applicator arrangement according to claim 6, wherein the drive shaft is connected to the hollow shaft by a one way bearing, and wherein the one-way bearing runs freely in a label feed direction.

8. The applicator arrangement according to claim 1, wherein:
the label holder is configured to be in a feed position when the label is obtained from a label dispenser;
the label holder is configured to be in a label release position when a backing paper is released from the label and when the label is being applied to the object,
the label holder is configured to pivot around a center point to move between the feed position and the label release position, and
a part of the label holder that is closest located to the label dispenser is configured to move in the first direction when moving from the feed position to the label release position.

9. The applicator arrangement according to claim 8, wherein the label holder comprises a loop or bracket configured to catch an applicator pad of the label applicator such that movement of the applicator pad in the second direction moves the label holder towards a label change position.

10. The applicator arrangement according to claim 9, wherein a part of the label holder is configured to move in the second direction from the label release position to the label change position.

11. (canceled)

12. The applicator arrangement according to claim 1. wherein the the label applicator comprises an outer rod configured to at least partly encapsulate an inner rod, and the inner rod is configured to move in a first direction out of the outer rod and in a second direction into the outer rod, the label applicator further comprising an applicator pad positioned at an end of the inner rod, the applicator pad being configured to hold the label and to apply the label to the object.

13. (canceled)

14. The applicator arrangement according to claim 12, comprising a fan configured to suck air out from the outer rod of the label applicator thereby enabling the label to be held by the applicator pad.

15. The applicator arrangement according to claim 12, wherein an end cap is arranged at a top end of the outer rod of the label applicator.

16. The applicator arrangement according to claim 12, wherein the label applicator comprises a seal arranged between the inner rod and the outer rod.

17. The applicator arrangement according to claim 12, wherein the label applicator comprises at least one roller configured to guide the inner rod during movement in and out of the outer rod.

18. The applicator arrangement according to claim 12, wherein the label applicator comprises at least three rollers, wherein each roller is located on an outside surface of the inner rod.

19. The applicator arrangement according to claim 12, wherein the label applicator comprises a friction belt arranged on an outer surface of the outer rod.

20. (canceled)

21. The applicator arrangement according to claim 12, comprising a sensor configured to detect a position of the inner rod in the outer rod.

22. The applicator arrangement according to claim 12, wherein the applicator pad is made of a flexible and compressible material, and the applicator pad comprises a cut out in a center position.

23. The applicator arrangement according to claim 12, wherein a first side of the applicator pad connected to the end of the inner rod, and wherein a second side of the applicator pad is configured to contact the label, and wherein the second side of the applicator pad is configured to create a fold along a center of the label when the applicator pad touches the label.

24. The applicator arrangement according to claim 12, wherein the applicator pad comprises a disconnecting device configured to disconnect the applicator pad from the object after application of the label.

25. The applicator arrangement according to claim 22, wherein the label applicator comprises a detector configured to detect that the label has hit the object and that the applicator pad has been compressed, and the label applicator is configured to stop moving towards the object when compression of the applicator pad has been detected.

26. A method performed by a control unit of an applicator arrangement to apply a label to an object, the method comprising:
controlling provision of a first label from a label dispenser to a label holder; and
when the label holder has received the first label, controlling at least a part of a label applicator to pass through an opening in the label holder, to touch the first label and apply the first label to the object; and
controlling at least a part of the label applicator to pass through the opening in the label holder in a second direction that is opposite the first direction after the first label has been applied to the object.

27. The label applicator arrangement of claim 1, comprising a control unit configured to operate the label applicator to pass at least part of the label applicator through the opening of the label holder in the first direction and in the second direction for application of the label to an object.

28. (canceled)

29. A non-transitory computer-readable storage medium comprising instructions, which when executed by a processing circuitry, cause the processing circuitry to perform operations comprising:
controlling provision of a label from a label dispenser to a label holder;
when the label holder has received the label, controlling at least a part of a label applicator to pass through an opening in the label holder in a first direction, to touch the label and apply the label to an object; and
controlling at least the part of the label applicator to pass through the opening in the label holder in a second direction that is opposite the first direction after the label has been applied to the object.
